(19) United States
(12) Patent Application Publication
(10) Pub. No.: US 2026/0215487 A1
(43) Pub. Date: Jul. 30, 2026

(54) AEROSOL-GENERATING ARTICLE FOR USE WITH AN INDUCTIVELY HEATING AEROSOL-GENERATING DEVICE

(71) Applicant: Philip Morris Products S.A., Neuchatel (CH)

(72) Inventors: Oleg MIRONOV, Cudrefin (CH); Andreas Michael ROSSOLL, Le Mont-sur-Lausanne (CH); Alessio DI GIUSEPPE, Modena (IT); Lorenzo BENASSI, Bologna (IT); Julien VIDAL, Peseux (CH)

(73) Assignee: Philip Morris Products S.A., Neuchatel (CH)

(21) Appl. No.: 19/150,214

(22) PCT Filed: Jan. 31, 2024
(86) PCT No.: PCT/EP2024/052343

§ 371 Date: Jul. 23, 2025

(30) Foreign Application Priority Data
Jan. 31, 2023 (EP) 23154220

(51) Int. Cl. A24D 1/20; A24D 1/00; A24F 40/20; A24F 40/465

(52) U.S. Cl. CPC A24D 1/20; A24D 1/002; A24F 40/20; A24F 40/465

(57) ABSTRACT

An aerosol-generating article for an inductively heating aerosol-generating device is provided, including: an aerosol-forming substrate; and a susceptor arrangement to heat the substrate by interaction of the arrangement with an alternating magnetic field provided by the device, the arrangement including 1D-elongate susceptor elements having a greater extent in one predominant dimension than in the two remaining dimensions, the susceptor elements including a ferromagnetic or ferrimagnetic susceptor material and being dispersed throughout the substrate, the susceptor elements further including a ferromagnetic or ferrimagnetic temperature marker material in addition to the susceptor material, the susceptor material being surrounded by the temperature marker material, an aspect ratio of a maximum extent of the susceptor elements in the one predominant dimension to a maximum extent of the susceptor elements in the remaining dimensions being greater than 4, and the susceptor elements being fiber elements, or wire elements, or thread elements, or grain elements.

The present disclosure relates to an aerosol-generating article for use with an inductively heating aerosol-generating device. The disclosure further relates to an aerosol-generating system comprising such an article and an inductively heating aerosol-generating device for use with the article.

Aerosol-generating systems using induction heating for generating inhalable aerosols are generally known from prior art. Such systems may comprise an inductively heating aerosol-generating device and a separate aerosol-generating article for use with the device. Among other components, the article may include an aerosol-forming substrate capable to form an inhalable aerosol when heated, and an inductively heatable susceptor arrangement in thermal proximity or direct physical contact with the substrate for heating the same. Inductive heating of the susceptor arrangement is accomplished by interaction of the susceptor arrangement with an alternating magnetic field that is provided by the aerosol-generating device. In operation, the alternating magnetic field induces at least one of heat-generating eddy currents or hysteresis losses in the susceptor arrangement, causing the latter to heat up to a temperature sufficient to release volatile compounds from the heated substrate, which subsequently can cool down to form an aerosol.

Depending on the type of substrate and the shape of the article, different configurations of susceptor element susceptor arrangements are known. As an example, the article may comprise a single solid susceptor element, such as a susceptor strip, that is embedded in a solid or gel-like aerosol-forming substrate within a substrate portion of the article. While solid susceptor element are easily available at low cost, they form a single central heat source which can result in inhomogeneous temperature distribution over the substrate portion. This is because direct heating of the substrate only occurs in the immediate vicinity of the susceptor element, while peripheral regions of the substrate portions are heated only indirectly by means of heat conduction across adjacent substrate layers. In particular, the high temperature gradient may cause the inner regions of the substrate portion in the vicinity of the susceptor element to overheat, whereas the temperature in the peripheral regions of the substrate portion may be too low for volatilizing the substrate. Moreover, the heating efficiency of this configuration is rather sensitive to a proper positioning of the susceptor element within the substrate. All this may cause a non-optimal exploitation of the aerosol-forming substrate. Alternatively, articles have been proposed that comprise spherical or quasi-spherical susceptor particles homogenously disturbed throughout the aerosol-forming substrate. Whilst leading to a more homogenous heating of the substrate, the heating efficiency of this susceptor configuration is limited which may also impact the extraction efficiency.

Therefore, it would be desirable to have an inductively heatable aerosol-generating article and an aerosol-generating system comprising such an article with the advantages of prior art solutions, whilst mitigating their limitations. In particular, it would be desirable to have an inductively heatable aerosol-generating article and an aerosol-generating system comprising such an article which provide a more efficient heating and exploitation of the aerosol-forming substrate.

According to an aspect of the present invention, there is provided an aerosol-generating article for use with an inductively heating aerosol-generating device. The article comprises an aerosol-forming substrate and a susceptor arrangement for heating the aerosol-forming substrate by interaction of the susceptor arrangement with an alternating magnetic field that is provided by the aerosol-generating device. The susceptor arrangement comprises a plurality of 1D-elongate or 2D-elongate susceptor elements, the 1D-elongate susceptor elements having a greater extent in one predominant dimension than in the two remaining dimensions, the 2D-elongate susceptor element having a greater extent in two predominant dimensions than in the remaining dimension. The 1D-elongate or 2D-elongate susceptor elements comprise or consist of a susceptor material, preferably a ferromagnetic or ferrimagnetic susceptor material, and are dispersed throughout the aerosol-forming substrate. Preferably, an aspect ratio of a maximum extent of the 1D-elongate or 2D-elongate susceptor elements in the one or two predominant dimensions, respectively, to a maximum extent of the 1D-elongate or 2D-elongate susceptor elements in the remaining (non-prominent) dimension(s) is greater than 4.

As used herein, the term “1D-elongate susceptor element” (synonym for one-dimensionally-elongate susceptor element) refers to a susceptor element having a greater extent in one predominant dimension than in the two remaining dimensions perpendicular to the predominant dimension. As such, the 1D-elongate susceptor element may also be denoted as quasi-one-dimensional susceptor element or quais-1D susceptor element. In particular, the term “1D-elongate susceptor element” may refer to a susceptor element that has a length dimension greater than any transverse dimension perpendicular to the length dimension. More particularly, the 1D-elongate susceptor element may be an elongate or a prolate susceptor element.

Likewise, as used herein, the term “2D-elongate susceptor element” (synonym for two-dimensionally-elongate susceptor element) refers to a susceptor element having a greater extent in two (perpendicular) predominant dimensions than in the remaining dimension perpendicular to the predominant dimensions. As such, the 2D-elongate susceptor element may also be denoted as quasi-two-dimensional susceptor element or quais-2D susceptor element. In particular, the term “2D-elongate susceptor element” may refer to a susceptor element that has a length dimension and a width dimension greater than a thickness direction, wherein the length dimension may be either greater than or substantially similar to the width dimension. More particularly, the 2D-elongate susceptor element may be an oblate susceptor element.

As compared to a single solid susceptor element, usage of a plurality of susceptor elements which are dispersed throughout the aerosol-forming substrate advantageously results in a more homogenous heat distribution over the substrate without any significant temperature gradients across different substrate regions. Furthermore, where the susceptor material of the susceptor elements has a high thermal conductivity, the homogeneity of the heat distribution is further enhanced by the fact that a substrate comprising a plurality of susceptor elements dispersed therein exhibits an increased equivalent thermal conductivity as compared to a substrate without susceptor elements or with a single solid susceptor element only. Moreover, in achieving a homogeneous heat distribution, the proposed susceptor arrangement is less sensitive to the positioning of the susceptor elements as compared to a single solid susceptor element.

Most important, it was found that the geometry, in particular the relative dimensions of the susceptor elements have a major impact on the heating efficiency and thus on the extraction efficiency of the substrate. In this regard, it was found that susceptor elements which are elongate in one or two dimensions as compared to the remaining dimension(s) are less prone to demagnetization effects as compared to rather equidimensional susceptor elements, such as spherical or quasi-spherical susceptor particles. This can be explained as follows: When placing a susceptor element in an external magnetic field, it becomes progressively magnetized. As the external field increases, so does the internal magnetization. This process continues until the magnetization reaches the magnetic saturation point of the material, beyond which no further magnetization can occur. As a result, the magnetization of the susceptor element causes an accumulation of magnetic charge density at opposite ends of the susceptor element as seen in the direction of the external magnetic field. As a consequence, the susceptor element generates a magnetic field that causes a self-interaction with its material. This field lies along the same direction as the external magnetic field, but points opposite to it, and thus is termed the demagnetization field. The demagnetizing field depends on the geometrical shape of the susceptor element, but not on its absolute dimensions. Provided the susceptor element responds to the external magnetic field changes, the demagnetizing field is generally assumed to be proportional to the magnetization in each direction, related by a geometry dependent constant of proportionality that is known as the demagnetization factor. The demagnetization factor depends on the shape of the susceptor element as well as on its relative orientation to the external magnetic field. To this extent, it has been found that an external magnetic field running through a 1D-elongate or 2D-elongate susceptor element substantially in parallel to the one or two predominant dimensions, respectively, generates a weaker or even negligible demagnetization field as compared to an equidimensional susceptor element having a size on the order of the extent along the non-prominent dimension(s). This can be intuitively understood since in a properly aligned 1D-elongate or 2D-elongate susceptor element the accumulated magnetic charge densities at the opposite ends of the susceptor element are more spatially distanced from each other. This causes the demagnetizing field to significantly reduce its intensity and thus to have a lesser impact on the magnetization field, which is responsible for the power losses. As a result, power losses and thus heating efficiency is greater for a 1D-elongate or 2D-elongate susceptor element than for an equidimensional susceptor element. This applies especially where the magnetic field is essentially parallel to the maximum extent of the 1D-elongate or 2D-elongate susceptor elements in the one or two predominant dimensions, respectively. Nevertheless, when considering an ensemble of susceptor elements, the overall heating performance of an ensemble of 1D-elongate or 2D-elongate susceptor elements is still higher on statistical average than that of an ensemble of equidimensional susceptor elements, even if the 1D-elongate or 2D-elongate susceptor elements are not all aligned in parallel to the alternating magnetic field but are randomly oriented. Hence, in any case the overall heating performance of the proposed susceptor arrangement of a plurality of 1D-elongate or 2D-elongate susceptor elements is higher than for a similar configuration of equidimensional susceptor elements, regardless of whether the 1D-elongate or 2D-elongate susceptor elements are dispersed throughout the substrate with random orientation or in parallel orientation with the alternating magnetic field used for induction heating.

Altogether, the high power available, the increased thermal conductivity of the substrate, and the homogeneous heat distribution into the substrate allow for a fast heating of the aerosol-forming substrate. Advantageously, the heating time may be lower than 0.5 milliseconds. The reduced heating time and the low thermal gradient across the substrate even allow to realize a puff-on-demand strategy, which is based on delivering instantaneous or quasi-instantaneous power in order to heat up the substrate and to generate an aerosol only when the user demands it while during the waiting dwell-time the power supplied to the substrate is low or zero.

According to the invention, it was found that the heating efficiency and thus the extraction efficiency of the substrate is particularly enhanced, if an aspect ratio of a maximum extent of the 1D-elongate or 2D-elongate susceptor elements in the one or two predominant dimensions, respectively, to a maximum extent of the 1D-elongate or 2D-elongate susceptor elements in the remaining (non-prominent) dimension(s) is greater than 4, in particular greater than 10, preferably greater than 20, more preferably greater than 25, even more preferably greater than 30, most preferably greater than 35. As used herein, the aspect ratio of the maximum extent of the 1D-elongate or 2D-elongate susceptor elements in the one or two predominant dimensions, respectively, to the maximum extent in the remaining (non-prominent) dimension(s) is also denoted as form factor. Accordingly, the form factor of the 1D-elongate or 2D-elongate susceptor elements may be greater than 4, in particular greater than 10, preferably greater than 20, more preferably greater than 25, even more preferably greater than 30, most preferably greater than 35.

Whenever in this disclosure a number or a range is given for a plurality of a objects, such as for the plurality of susceptor elements, this means that the number or the range applies to at least 60 percent, in particular at least 70 percent, more particularly at least 80 percent, especially at least 90 percent of all objects out of the plurality of a objects, preferably for all objects out of the plurality of a objects. For example, where the present disclosure states that the aspect ratio or the form factor of the 1D-elongate or 2D-elongate susceptor elements is greater than A, this means that the aspect ratio or the form factor for at least 60 percent, in particular at least 70 percent, more particularly at least 80 percent, especially at least 90 percent of all 1D-elongate or 2D-elongate susceptor elements of the susceptor arrangement is greater than A.

Preferably, the aspect ratio or the form factor does not only have a lower limit but also an upper limit. Accordingly, the aspect ratio of the maximum extent of the 1D-elongate or 2D-elongate susceptor elements in the one or two predominant dimensions, respectively, to the maximum extent in the remaining (non-prominent) dimension(s), that is, the form factor of the 1D-elongate or 2D-elongate susceptor elements may be a range between 4 and 500, in particular between 10 and 300, preferably between 20 and 200, more preferably between 30 and 100.

In absolute numbers, the maximum extent of the 1D-elongate or 2D-elongate susceptor elements in the one or two predominant dimensions, respectively, may be in a range between 0.02 micrometer and 50 millimeter, in particular 1 micrometer and 16 millimeter, preferably between 0.1 millimeter and 5 millimeter. Such maximum extents in the one or two predominant dimensions prove advantageous with regard to dispersing the susceptor elements throughout the aerosol-forming substrate.

Depending on the respective absolute values of the maximum extents in the one or two predominant dimensions, the respective absolute value of the maximum extent in the remaining (non-prominent) dimension(s) is chosen such that the form factor is above the above-defined lower limit, advantageously also within the above-defined preferred ranges. Accordingly, the maximum extent in the remaining (non-prominent) dimension(s) of the 1D-elongate or 2D-elongate susceptor elements may be equal to or smaller than 500 micrometer, in particular 100 micrometer, preferably 10 micrometer, more preferably 1 micrometer. Likewise, the maximum extent in the remaining (non-prominent) dimension(s) of the 1D-elongate or 2D-elongate susceptor elements may be in a range between 0.005 micrometer and 500 micrometer, in particular 0.1 micrometer and 150 micrometer, preferably 20 micrometer and 100 micrometer. As an example, a 1D-elongate susceptor elements may have a length extent (maximum extent in the one predominant dimension) of about 2 millimeter and maximum transverse extent (maximum extent in the two remaining (non-prominent) dimensions) of about 25 micrometer. Likewise, as another example, a 2D-elongate susceptor elements may have an equal width and length extent (maximum extents in the two predominant dimensions) of about 1 millimeter and maximum thickness extent (maximum extent in the one remaining (non-prominent) dimension) of about 25 micrometer.

The heating efficiency and thus the extraction efficiency of the substrate depends not only on the geometry, in particular the relative dimensions of the 1D- or 2D-elongate susceptor elements, but also on their orientation relative to the alternating magnetic field used to for inductive heating. In this regard, it has been found that the overall heating performance of the 1D- or 2D-elongate susceptor elements increases with a decreasing deviation from an alignment of the predominant dimension(s) substantially parallel to the alternating magnetic field used for induction heating. For a substantially parallel alignment, the heating performance is at maximum.

Accordingly, with respect to the maximum extent in the one or two predominant dimensions, respectively, the 1D-elongate or 2D-elongate susceptor elements are preferably aligned within the aerosol-forming substrate substantially parallel to a pre-defined reference axis of the article. Preferably, the pre-defined reference axis of the article is given by the orientation of the alternating magnetic field provided by the aerosol-generating device the article is to be used with. More particularly, the pre-defined reference axis may be defined by, that is, may correspond to or may be parallel to the orientation of the magnetic field lines at the position of the elongate susceptor elements when the aerosol-generating article is engaged with the device. For example, where in use the magnetic field lines at the position of the 1D- or 2D-elongate susceptor elements in the article run substantially parallel to a length axis of the article, the pre-defined reference axis of the article may correspond to the length axis of the article. Accordingly, with respect to the maximum extent in the one or two predominant dimensions, respectively, the 1D-elongate or 2D-elongate susceptor elements may be aligned within the aerosol-forming substrate substantially parallel to a length axis of the article. As used herein, the term “substantially parallel” is understood as “parallel+5° degrees deviation from a parallel arrangement”.

The 1D- or 2D-elongate susceptor elements do not necessarily need to be in perfect parallel alignment with a pre-defined reference axis of the article. Even if the 1D- or 2D-elongate susceptor elements are aligned in a certain angular range about a pre-defined reference axis of the article, in particular a length axis of the article, more particularly the orientation of the alternating magnetic field, the overall heating performance is still higher than for a susceptor arrangement with randomly oriented susceptor elements. Advantageously, the 1D- or 2D-elongate susceptor elements may be aligned within the aerosol-forming substrate such that an angle between the maximum extent in the one or two predominant dimensions, respectively, and a pre-defined reference axis of the article, in particular a length axis of the article, more particularly the orientation of the alternating magnetic field in use with an aerosol-generating device providing the field, is in a range between +30 degrees and −30 degrees, in particular between +25 degrees and −25 degrees, more particularly between +10 degrees and −10 degrees.

In general, 1D- or 2D—the elongate susceptor elements may be even randomly oriented within the aerosol-forming substrate, although the overall heating performance is lower for a random orientation than for an ensemble of 1D- or 2D-elongate susceptor elements aligned substantially in parallel to the alternating magnetic field used for induction heating. As mentioned above, even for a random orientation, the overall heating performance of an ensemble of 1D- or 2D-elongate susceptor elements is still higher on statistical average than that of an ensemble of non-elongate susceptor elements.

The heating efficiency also depends on the density of the 1D- or 2D-elongate susceptor elements within the aerosol-forming substrate. The higher the density, the larger the heating efficiency. Preferably, a (volume) density of the 1D- or 2D-elongate susceptor elements within the aerosol-forming substrate is in a range between 0.001 susceptor elements per cubic millimeter and 30 susceptor elements per cubic millimeter, in particular between 0.1 susceptor elements per cubic millimeter and 10 susceptor elements per cubic millimeter. Likewise, a mass density of the 1D-elongate or 2D-elongate susceptor elements within the aerosol-forming substrate may be in a range between 0.002 milligram of susceptor mass per cubic millimeter and 0.3 milligram susceptor mass per cubic millimeter, in particular between 0.01 milligram of susceptor mass per cubic millimeter and 0.1 milligram of susceptor mass per cubic millimeter.

In general, the 1D-elongate or 2D-elonagte susceptor elements may have any geometrical shape, as long as it is elongate in one or two dimensions, respectively. In particular, the 1D-elongate susceptor elements may have one of an elongate cylindrical shape or a prolate-ellipsoidal shape. That is, the 1D-elongate susceptor elements may have a rod-like shape or a grain-like shape. Likewise, the 2D-elongate susceptor elements may have one of an oblate cylindrical shape, such as coin shape, or an oblate-ellipsoidal shape, such as a lens shape, or a flake shape or plate shape.

As an example, the 1D-elongate susceptor elements may be fiber elements, in particular chopped fiber elements or milled fiber elements. As another example, the 1D-elongate susceptor elements may be wire elements or thread elements or grain elements or filament elements or rod elements. Advantageously, the fiber elements or the wire elements or the thread elements or the grain elements or the filament elements or the rod elements are made of a material that is inductively heatable, such as metal fibers, or metal wires or metal threads, are easily available at low cost.

As seen a plane perpendicular to the one predominant dimension, that is, the length dimension of the 1D-elongate susceptor element, a cross-section of the 1D-elongate susceptor elements in a plane perpendicular to the one predominant dimension may have a circular shape or an oval shape or an elliptical shape or a triangular shape or a rectangular shape or a quadric shape or polygonal shape. If the cross-section is circular, the above mentioned maximum extent of the 1D-elongate susceptor elements in the remaining (non-predominant) dimensions corresponds to the diameter of the 1D-elongate susceptor elements where it is at maximum along the one predominant dimension, that is, the length dimension of the 1D-elongate susceptor elements. If the cross-section is oval or elliptical, the above mentioned maximum extent of the 1D-elongate susceptor elements corresponds to the length of the semimajor axis of the oval or elliptical cross-section, where it is at maximum along the one predominant dimension, that is, the length dimension of the 1D-elongate susceptor elements. If the cross-section is quadratic or in general rectangular, the above mentioned maximum extent of the 1D-elongate susceptor elements corresponds to the length of the edge/major edge of the quadratic/rectangular cross-section.

Likewise, a cross-section of the 2D-elongate susceptor elements in a plane parallel to the two predominant dimensions may have a circular shape or an oval shape or an elliptical shape or a triangular shape or a rectangular shape or a quadric shape or polygonal shape.

In general, the term “susceptor element” as used herein refers to an element comprising a susceptor material that is capable to convert electromagnetic energy into heat when subjected to an alternating magnetic field. This may be the result of at least one hysteresis losses and eddy currents induced in the susceptor material, depending on the electrical and magnetic properties of the susceptor material. Hysteresis losses occur in ferromagnetic or ferrimagnetic susceptor materials due to magnetic domains within the material being switched under the influence of an alternating electromagnetic field. Eddy currents may be induced, if the susceptor material is electrically conductive. In case of an electrically conductive ferromagnetic susceptor or an electrically conductive ferrimagnetic susceptor, heat can be generated due to both, eddy currents and hysteresis losses.

Preferably, the susceptor material of the 1D-elongate or 2D-elongate susceptor elements may be ferromagnetic or ferrimagnetic. In addition or alternatively, the susceptor material of the 1D-elongate or 2D-elongate susceptor elements may be electrically conductive. Alternatively, the susceptor material of the 1D-elongate or 2D-elongate susceptor elements may be electrically non-conductive. In general, the susceptor material of the 1D-elongate or 2D-elongate susceptor elements could be electrically conductive, but neither ferromagnetic nor ferrimagnetic.

Preferably, the susceptor material of the 1D-elongate or 2D-elongate susceptor elements comprises or consists of a metal, for example ferritic iron, or stainless steel, in particular a grade 410, grade 420, or grade 430 stainless steel. Alternatively, the susceptor material of the elongate susceptor elements may comprise a ferrimagnetic ceramic.

In addition to the susceptor material, the 1D-elongate or 2D-elongate susceptor elements may further comprise a ferromagnetic or ferrimagnetic temperature maker material. While the susceptor material is optimized with regard to heat loss and thus heating efficiency, the temperature marker material is a magnetic (ferro- or ferrimagnetic) material that is chosen such as to have a Curie temperature which essentially corresponds to a predefined temperature point of the heating process. When the temperature of the susceptor arrangement and the aerosol-forming substrate reaches the Curie temperature of the temperature maker material, the magnetic permeability of the temperature maker material drops to unity leading to a change of its magnetic properties from ferro- or ferrimagnetic to paramagnetic. The change of the magnetic properties is accompanied by a temporary change of the electrical resistance of the susceptor arrangement, as well as a temporary change of the inductance of the induction heating arrangement. Thus, by monitoring a corresponding change of the electrical current through the induction heating arrangement used for generating the alternating magnetic field that heats the susceptor arrangement, it can be detected when the temperature maker material has reached its Curie temperature and, thus, when the predefined temperature point has been reached.

In particular, the temperature maker material may be selected to have a Curie temperature which essentially corresponds to a predefined maximum heating temperature of the susceptor arrangement. The maximum desired heating temperature may be defined to be approximately the temperature that the susceptor arrangement should be heated to in order to generate an aerosol from the aerosol-forming substrate. However, the maximum desired heating temperature should be low enough to avoid local overheating or even burning of the aerosol-forming substrate. Preferably, the Curie temperature of the temperature maker material should be below an ignition point of the aerosol-forming substrate to be heated.

The temperature maker material may have a Curie temperature below 500° C., preferably equal to or below 400° C., in particular equal to or below 390° C. For example, the temperature maker material of the elongate susceptor elements may have a Curie temperature in a range between 180° C. and 420° C., in particular between 210° C. and 380° C., preferably between 250° C. and 380° C. Even though the temperature maker material primarily is a functional material providing a temperature marker by its Curie temperature, it may also contribute to the inductive heating process of the susceptor arrangement.

The temperature maker material of the 1D-elongate or 2D-elongate susceptor elements may comprise or may consist of nickel or a nickel alloy. As an example, the temperature maker material of the 1D-elongate or 2D-elongate susceptor elements may comprise or may consist of a Ni—Fe-alloy, in particular a Ni—Fe-alloy comprising 75 wt %-85 wt % Ni and 10 wt %-25 wt % Fe, more particularly a Ni—Fe-alloy comprising one of:
79 wt %-82 wt % Ni and 13 wt %-15 wt % Fe; or
79 wt %-82 wt % Ni, 4 wt %-6 wt % Mo, less than 1 wt % of Si and Mn combined together, and 13 wt %-15 wt % Fe; or
77 wt % Ni, 16 wt % Fe, 5 wt % Cu, and 2 wt % of one of Cr and Mo; or 77 wt % Ni, 14 to 15 wt % Fe, 4 wt % Cu, and 4 wt % of Mo.

As anther example, the temperature marker material may comprise or may consists of a Fe—Ni—Cr alloy, in particular a Fe—Ni—Cr alloy comprising one of
50 wt % Ni, 11 wt % Cr and rest Fe (commercial alloy available under the tradename Phytherm 210 having a Curie temperature of about 210° C.); or
50 wt % Ni, 10 wt % Cr and rest Fe (commercial alloy available under the tradename Phytherm 230 having a Curie temperature of about 230° C.); or
50 wt % Ni, 9 wt % Cr and rest Fe (commercial alloy available under the tradename Phytherm 260 having a Curie temperature of about 260° C.), or
50 wt % Ni, 9 wt % Cr, up to 1 wt % Si and up to 1 wt % Mn, the rest being Fe; or
50 wt % Ni, 10 wt % Cr, up to 1 wt % Si and up to 1 wt % Mn, the rest being Fe; or
50 wt % Ni, 11 wt % Cr, up to 1 wt % Si and up to 1 wt % Mn, the rest being Fe.

As yet another example, the temperature maker material of the 1D-elongate or 2D-elongate susceptor elements may comprise or may consist of a Ni—Fe-alloy available from Hitachi under name “MS-10”, which has a Ni content of 36.1 wt % and a Curie temperature of 213° C. Likewise, the temperature maker material of the elongate susceptor elements may comprise or may consist of a Ni—Fe-alloy available from Hitachi under name “MS-16”, which has a Ni content of 36.4 wt % and a Curie temperature of 221.5° C.

The susceptor elements may be formed such that the susceptor material is surrounded or covered at least partially, preferably entirely by the temperature maker material. That is, the temperature maker material may be a coating or a layer surrounding or covering the susceptor material at least partially, preferably entirely. Vice versa, the susceptor elements may be formed such that the temperature maker material is surrounded or covered at least partially, preferably entirely by the susceptor material. That is, the susceptor material may be a coating or a layer surrounding covering the temperature maker material at least partially, preferably entirely.

Advantageously, the temperature maker material and the susceptor material may be intimately coupled to each other. For example, one of the temperature maker material and the susceptor material may be plated, deposited, coated, cladded or welded onto the respective other material. In particular, one of the temperature maker material and the susceptor material may be applied onto the respective other material by spraying, dip coating, roll coating, electroplating or cladding. Any of the configurations described above falls within the term “intimately coupled” as used herein.

In addition, the 1D-elongate or 2D-elongate susceptor elements may comprise an outer protective coating surrounding the susceptor material and—if present—the temperature marker material. Preferably, the protective coating is an anti-corrosion coating. Advantageously, the protective coating makes the 1D-elongate or 2D-elongate susceptor elements resistant to external influences, especially corrosive influences.

It is also possible that the susceptor material of the susceptor elements itself has a temperature marker function. That is, the 1D-elongate or 2D-elongate susceptor elements may comprise a single material which acts both as a susceptor material and as a temperature marker material. For example, this single material may be one of the materials mentioned above with respect to the susceptor temperature marker material in addition to the susceptor material.

Alternatively to or in addition to the temperature marker material as part of the elongate susceptor elements, the susceptor arrangement may comprise one or more susceptive temperature maker elements in addition to the plurality of elongate susceptor elements.

Like the susceptor elements, the one or more temperature maker elements may comprise or consist of a ferromagnetic or ferrimagnetic temperature maker material. Like the temperature maker material of the susceptor elements, the ferromagnetic or ferrimagnetic temperature maker material of the one or more temperature maker elements may be chosen such as to have a Curie temperature which essentially corresponds to a predefined temperature point of the heating process, in particular to a predefined maximum heating temperature of the susceptor arrangement. Accordingly, the susceptive temperature maker material of the one or more temperature maker elements may have a Curie temperature below 500° C., preferably equal to or below 400° C., in particular equal to or below 390° C. For example, the temperature maker material of the temperature maker elements may have a Curie temperature in a range between 180° C. and 420° C., in particular between 210° C. and 380° C., preferably between 250° C. and 380° C.

The ferromagnetic or ferrimagnetic temperature maker material of the one or more temperature maker elements may be one of the materials disclosed above with respect to the temperature maker material of the susceptor elements. That is, the ferromagnetic or ferrimagnetic temperature maker material of the one or more temperature maker elements may comprise or may consist of nickel or a nickel alloy. As an example, the temperature maker material of the one or more temperature maker elements may comprise or may consist of a Ni—Fe-alloy, in particular a Ni—Fe-alloy comprising 75 wt %-85 wt % Ni and 10 wt %-25 wt % Fe, more particularly Ni—Fe-alloy comprising one of:
79 wt %-82 wt % Ni and 13 wt %-15 wt % Fe; or
79 wt %-82 wt % Ni, 4 wt %-6 wt % Mo, less than 1 wt % of Si and Mn combined together, and 13 wt %-15 wt % Fe; or
77 wt % Ni, 16 wt % Fe, 5 wt % Cu, and 2 wt % of one of Cr and Mo; or
77 wt % Ni, 14 to 15 wt % Fe, 4 wt % Cu, and 4 wt % of Mo.

As another example, the temperature marker material of the one or more temperature maker elements may comprise or may consists of a Fe—Ni—Cr alloy, in particular a Fe—Ni—Cr alloy comprising one of
50 wt % Ni, 11 wt % Cr and rest Fe (commercial alloy available under the tradename Phytherm 210 having a Curie temperature of about 210° C.); or
50 wt % Ni, 10 wt % Cr and rest Fe (commercial alloy available under the tradename Phytherm 230 having a Curie temperature of about 230° C.); or
50 wt % Ni, 9 wt % Cr and rest Fe (commercial alloy available under the tradename Phytherm 260 having a Curie temperature of about 260° C.), or
50 wt % Ni, 9 wt % Cr, up to 1 wt % Si and up to 1 wt % Mn, the rest being Fe; or
50 wt % Ni, 10 wt % Cr, up to 1 wt % Si and up to 1 wt % Mn, the rest being Fe; or
50 wt % Ni, 11 wt % Cr, up to 1 wt % Si and up to 1 wt % Mn, the rest being Fe.

As yet another example, the temperature maker material of the one or more temperature maker elements may comprise or may consist of a Ni—Fe-alloy available from Hitachi under name “MS-10”, which has a Ni content of 36.1 wt % and a Curie temperature of 213° C. Likewise, the temperature maker material of the elongate susceptor elements may comprise or may consist of a Ni—Fe-alloy available from Hitachi under name “MS-16”, which has a Ni content of 36.4 wt % and a Curie temperature of 221.5° C.

Like the susceptor elements, the temperature maker elements may be dispersed throughout the aerosol-forming substrate.

Vice versa, it is also possible that the susceptor arrangement comprises a single temperature maker element which is arranged in the aerosol-generating article such as to experience the alternating magnetic field provided by the aerosol-generating device which the aerosol-generating article is to be used with.

In general, the one or more temperature maker elements may be particulate temperature maker elements or equidimensional temperature maker elements or 1D-elonagte temperature maker elements or 2D-elongate temperature maker elements, in particular 1D-elonagte or 2D-elongate temperature maker elements having the same shape and/or the same dimensions as the 1D-elongate or 2D-elongateelongate susceptor elements. Where the susceptor arrangement comprises a single temperature maker element, the single temperature maker element may have the shape of or may be one of a rod element, a pin element, a blade element, a grain element, a sheet element, a mesh element, a thread element, a fiber element, a wire element or a filament element. Where the susceptor arrangement comprises a plurality of temperature maker elements, the temperature maker elements may have the shape of or may be one of a grain element, a thread element, a fiber element, a wire element or a filament element, spherical or quasi-spherical element, an oblate cylindrical element or an oblate-ellipsoidal element or a flake element or plate element.

Where the temperature marker elements have a 1D-elonagte or 2D-elongate shape, the temperature marker elements may be dispersed thorough the aerosol-forming substrate-similar to the elongate susceptor elements-either with random orientation or within a certain angular range or in parallel orientation to a pre-defined article axis. In particular, the temperature marker elements may be aligned within the aerosol-forming substrate such that an angle between a maximum extent of the 1D-elonagte or 2D-elongate susceptor elements in the one or two predominant dimensions, respectively, and a pre-defined reference axis of the article, in particular a length axis of the article, is in a range between +30 degrees and −30 degrees, in particular between +25 degrees and −25 degrees, more particularly between +10 degrees and −10 degrees. Again, the pre-defined reference axis of the article preferably is given by the orientation of the alternating magnetic field provided by the aerosol-generating device the article is to be used with.

Like the 1D-elonagte or 2D-elongate susceptor elements, the one or more temperature maker elements may comprise an outer protective coating, in particular an outer anti-corrosion coating in order to make the one or more temperature maker elements resistant to external influences, especially corrosive influences.

As used herein, the term “aerosol-generating article” refers to an article comprising at least one aerosol-forming substrate that is capable of releasing volatile compounds when heated in order to form an aerosol. The aerosol-generating article may be a consumable, in particular a consumable to be discarded after a single use. For example, the article may be an elongate article or a rod-shaped article. The elongate or rod-shaped article may have a shape resembling the shape of conventional cigarettes. In particular, such an article may have a circular or elliptical or oval or square or rectangular or triangular or a polygonal cross-section. As another example, the article may be a cartridge including a liquid aerosol-forming substrate to be heated.

As used herein, the term “aerosol-forming substrate” denotes a substrate formed from or comprising an aerosol-forming material that is capable of releasing volatile compounds upon heating in order to generate an aerosol. Preferably, the aerosol-forming substrate is intended to be heated rather than combusted in order to release the aerosol-forming volatile compounds. Accordingly, such a substrate may be denoted as a heat-not-burn aerosol-forming substrate. Likewise, an aerosol-generating article comprising such an aerosol-forming substrate may be denoted as a heat-not-burn aerosol-generating article.

In general, the aerosol-forming substrate may comprise at least one aerosol former and at least one sensorial material both of which are volatilizable when heated. The sensorial material may comprise at least one of a tobacco-containing material, a nicotine-containing material and a flavoring substance. Examples of suitable aerosol formers are glycerin and propylene glycol. Examples of flavoring substance may be plant extracts and natural or artificial flavors.

The aerosol-forming substrate may be a solid aerosol-forming substrate, a liquid aerosol-forming substrate, a gel-like aerosol-forming substrate, or any combination thereof. For example, the aerosol-forming substrate may comprise both solid and liquid components.

As mentioned above, the aerosol-forming substrate may comprise a tobacco-containing material containing volatile tobacco flavor compounds, which are released from the substrate upon heating. For example, the aerosol-forming substrate may comprise a porous substrate or foam based on tobacco fibers or a filler comprising a cut tobacco material. In particular, the aerosol-forming substrate may comprise reconstituted tobacco material or a tobacco-containing slurry. Accordingly, the aerosol-generating article may be a tobacco containing article. Alternatively or additionally, the aerosol-forming substrate may comprise a non-tobacco material. For example, the aerosol-forming substrate may comprise a porous substrate or foam based on botanical fibers, or a filler comprising a cut botanical material, or cellulose fibers or cellulose-based fibers including a flavoring substance. The aerosol-forming substrate may also comprise other additives and ingredients, such as nicotine or flavourants.

As another example, the article may comprise a plurality of 1D-elonagte or 2D-elongate susceptor elements combined with an aerosol-forming substrate comprising a nicotine-containing material, organic fibers, a binder, an aerosol former. According to yet another example, the article may comprise a plurality of 1D-elonagte or 2D-elongate susceptor elements in contact with a substrate containing tobacco cut filler. As still another example, the article may comprise a plurality of 1D-elonagte or 2D-elongate susceptor elements embedded in a gel-like aerosol-forming substrate. In particular, the aerosol-forming substrate may also be a paste-like material, a sachet of porous material comprising aerosol-forming substrate, or, for example, loose tobacco mixed with a gelling agent or sticky agent, which could include a common aerosol former such as glycerin, and which is compressed or molded into a plug.

Preferably, the aerosol-forming substrate is made from a sheet material. For example, the aerosol-forming substrate may be made from a crimped tobacco sheet comprising a tobacco material, organic fibers, a binder, an aerosol former. Alternatively, the aerosol-forming substrate may be made from a sheet material including a nicotine-containing material, organic fibers, a binder, an aerosol former. As yet another alternative, the aerosol-forming substrate may be made from a sheet material containing tobacco cut filler. To this extent, it has been found that the aerosol-generating article is easy to manufacture, especially with respect to a preferred alignment of the 1D-elonagte or 2D-elongate susceptor elements relative to a pre-defined reference axis of the article, if the susceptor elements are applied to the aerosol-forming substrate when it is in the form of a sheet material. This may be the result of a manufacturing process including the deposition of the susceptor elements on an outer surface of a sheet material, either during a primary process, in which the sheet material is produced, or during a secondary process, where the sheet material is machined and combined with other semi-finished goods to obtain the final product. As a result of this, the 1D-elonagte or 2D-elongate susceptor elements may be finally disposed on an outer surface of the sheet material or at least partially embedded in the sheet material close to an outer surface of the sheet material. This can be observed even if the sheet material is subsequently machined, for example, crimped and gathered such as to form a substrate plug in the final article. If present, the one or more temperature maker elements may also be disposed on the outer surface of the sheet material or at least partially embedded in the sheet material close to an outer surface of the sheet material, as described before with respect to the 1D-elonagte or 2D-elongate susceptor elements.

Preferably, the aerosol-generating article may be a rod-shaped article. In particular a cylindrical article comprising one or more of the following elements: a distal front plug element, a substrate element, a first tube element, a second tube element, and a filter element. The substrate element preferably comprises the at least one aerosol-forming substrate to be heated and the susceptor arrangement with the plurality of 1D-elonagte or 2D-elongate susceptor elements dispersed throughout the substrate. The substrate element may have a length of 10 millimeter to 14 millimeter, for example, 12 millimeter. The susceptor arrangement may extend along the entire length of the substrate element or may have a length extension shorter than the length of the substrate element.

The first tube element is more distal than the second tube element. Preferably, the first tube element is proximal of the substrate element, whereas the second tube element is proximal of the first tube element and distal of the filter element, that is, between the first tube element and the filter element. At least one of the first tube element and the second tube element may comprise a central air passage. A cross-section of the central air passage of the second tube element may be larger than a cross-section of the central air passage of the first tube element. Preferably, at least one of the first tube element and the second tube element may comprise a hollow cellulose acetate tube. At least one of the first tube element and the second tube element may have a length of 6 millimeter to 10 millimeter, for example, 8 millimeters.

The filter element preferably serves as a mouthpiece, or is part of a mouthpiece together with the second tube element. As used herein, the term “mouthpiece” refers to a portion of the article through which the aerosol exits the aerosol-generating article. The filter element may have a length of 10 millimeter to 14 millimeter, for example, 12 millimeter.

The distal front plug element may be used to cover and protect the distal front end of the substrate element. The distal front plug element may have a length of 3 millimeter to 6 millimeter, for example, 5 millimeter. The distal front plug element may be made of the same material as the filter element

All of the aforementioned elements may be sequentially arranged along a length axis of the article in the above described order, wherein the distal front plug element preferably is arranged at a distal end of the article and the filter element preferably is arranged at a proximal end of the article. Each of the aforementioned elements may be substantially cylindrical. In particular, all elements may have the same outer cross-sectional shape and/or dimensions.

In addition, the elements may be circumscribed by one or more outer wrappers such as to keep the elements together and to maintain the desired cross-sectional shape of the rod-shaped article. Preferably, the wrapper is made of paper. The wrapper may further comprise adhesive that adheres the overlapped free ends of the wrapper to each other. For example, the distal front plug element, the substrate element and the first tube element may be circumscribed by a first wrapper, and the second tube element and the filter element may be circumscribed by a second wrapper. The second wrapper may also circumscribe at least a portion of the first tube element (after being wrapped by the first wrapper, i.e. on top of the first wrapper) to connect the distal front plug element, the substrate element and the first tube element being circumscribed by a first wrapper to the second tube element and the filter element. The second wrapper may comprise perforations around its circumference.

According to another aspect of the present invention, there is also provided an aerosol-generating system comprising an aerosol-generating article according to the present invention and as described herein, as well as an inductively heating aerosol-generating device for use with the aerosol-generating article.

As used herein, the term “aerosol-generating device” describes an electrically operated device for interaction with an aerosol-generating article in order to generate an aerosol by heating the aerosol-forming substrate within the article via interaction of the susceptor arrangement with an alternating magnetic field provided by the device. Preferably, the aerosol-generating device is a puffing device for generating an aerosol that is directly inhalable by a user through the user's mouth. In particular, the aerosol-generating device is a hand-held aerosol-generating device.

The device may comprise a receiving cavity for removably receiving at least a portion of the respective aerosol-generating article.

The aerosol-generating device may further comprise an inductive heating arrangement configured and arranged to generate an alternating magnetic field in the receiving cavity in order to inductively heat the susceptor arrangement when the article is received in the cavity.

For generating the alternating magnetic field, the inductive heating arrangement may comprise at least one induction coil surrounding at least a portion of the susceptor arrangement in use of the system. The at least one induction coil may be a helical coil or flat planar coil, in particular a pancake coil or a curved planar coil. The aerosol-generating device and the aerosol-generating article are preferably configured such that the susceptor arrangement is arranged within the cavity of the device, in particular within an interior space of the at least one induction coil, such as to experience the alternating magnetic field, when the article is received in the aerosol-generating device. The inductive heating arrangement may further comprise an alternating current (AC) generator. The AC generator may be powered by a power supply of the aerosol-generating device. The AC generator is operatively coupled to the at least one induction coil. In particular, the at least one induction coil may be integral part of the AC generator. The AC generator is configured to generate a high frequency oscillating current to be passed through the at least one induction coil for generating an alternating magnetic field. The AC current may be supplied to the at least one induction coil continuously following activation of the system or may be supplied intermittently, such as on a puff by puff basis. Preferably, the inductive heating arrangement comprises a DC/AC converter including an LC network, wherein the LC network comprises a series connection of a capacitor and the inductor. The DC/AC converter may be connected to a DC power supply.

The inductive heating arrangement preferably is configured to generate a high-frequency magnetic field. As referred to herein, a frequency of the high-frequency magnetic field may be in a range between 500 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz).

The aerosol-generating device may further comprise a controller configured to control operation of the heating process. The controller may be or may be part of an overall controller of the aerosol-generating device. The controller may comprise a microprocessor, for example a programmable microprocessor, a microcontroller, or an application specific integrated chip (ASIC) or other electronic circuitry capable of providing control. The controller may comprise further electronic components, such as at least one DC/AC converter and/or power amplifiers, for example a Class-C power amplifier or a Class-D power amplifier or Class-E power amplifier. In particular, the induction source may be part of the controller.

The aerosol-generating device may also comprise a power supply, in particular a DC power supply configured to provide a DC supply voltage and a DC supply current to the induction source. Preferably, the power supply is a battery such as a lithium iron phosphate battery. The power supply may be rechargeable. The power supply may have a capacity that allows for the storage of enough energy for one or more user experiences. For example, the power supply may have sufficient capacity to allow for the continuous generation of aerosol for a period of around six minutes or for a period that is a multiple of six minutes. In another example, the power supply may have sufficient capacity to allow for a predetermined number of puffs or discrete activations of the induction source.

Further features and advantages of the aerosol-generating system have been described with regard to the aerosol-generating article and thus equally apply.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating article for use with an inductively heating aerosol-generating device, the article comprises an aerosol-forming substrate and a susceptor arrangement for heating the aerosol-forming substrate by interaction of the susceptor arrangement with an alternating magnetic field provided by the aerosol-generating device, wherein the susceptor arrangement comprises a plurality of 1D-elongate or 2D-elongate susceptor elements, the 1D-elongate susceptor elements having a greater extent in one predominant dimension than in the two remaining dimensions, the 2D-elongate susceptor element having a greater extent in two predominant dimensions than in the remaining dimension, the 1D-elongate or 2D-elongate susceptor elements comprising a susceptor material, in particular a ferromagnetic or ferrimagnetic susceptor material, and being dispersed throughout the aerosol-forming substrate, wherein an aspect ratio of a maximum extent of the 1D-elongate or 2D-elongate susceptor elements in the one or two predominant dimensions to a maximum extent of the 1D-elongate or 2D-elongate susceptor elements in the remaining dimension(s) is greater than 4.

Example Ex2: The aerosol-generating article according to example Ex1, wherein the aspect ratio of the maximum extent of the 1D-elongate or 2D-elongate susceptor elements in the one or two predominant dimensions to the maximum extent in the remaining dimension(s) is greater than 10, preferably greater than 20, more preferably greater than 25, even more preferably greater than 30, most preferably greater than 35.

Example Ex3: The aerosol-generating article according to any one of the preceding examples, wherein the aspect ratio of the maximum extent of the 1D-elongate or 2D-elongate susceptor elements in the one or two predominant dimensions to the maximum extent in the remaining dimension(s) is in a range between 4 and 500, in particular between 10 and 300, preferably between 20 and 200, more preferably between 30 and 100.

Example Ex4: The aerosol-generating article according to any one of the preceding examples, wherein the maximum extent of the 1D-elongate or 2D-elongate susceptor elements in the one or two predominant dimensions is in a range between 0.02 micrometer and 50 millimeter, in particular 1 micrometer and 16 millimeter, preferably between 0.1 millimeter and 5 millimeter.

Example Ex5: The aerosol-generating article according to any one of the preceding examples, wherein the maximum extent of the 1D-elongate or 2D-elongate susceptor elements in the remaining dimension(s) is a range between 0.005 micrometer and 500 micrometer, in particular 0.1 micrometer and 150 micrometer, preferably 20 micrometer and 100 micrometer.

Example Ex6: The aerosol-generating article according to any one of the preceding examples, wherein the maximum extent of the 1D-elongate or 2D-elongate susceptor elements in the remaining dimension(s) is equal to or smaller than 500 micrometer, in particular 100 micrometer, preferably 10 micrometer, more preferably 1 micrometer.

Example Ex7: The aerosol-generating article according to any one of examples Ex1 to Ex6, wherein the 1D-elongate or 2D-elongate susceptor elements are randomly oriented within the aerosol-forming substrate.

Example Ex8: The aerosol-generating article according to any one of examples Ex1 to Ex6, wherein with respect to the maximum extent in the one or two predominant dimensions, respectively, the 1D-elongate or 2D-elongate susceptor elements are aligned within the aerosol-forming substrate substantially parallel to a pre-defined reference axis of the article, in particular to a length axis of the article.

Example Ex9: The aerosol-generating article according to any one of examples Ex1 to Ex6, wherein the 1D-elongate or 2D-elongate susceptor elements are aligned within the aerosol-forming substrate such that an angle between the maximum extent of the 1D-elongate or 2D-elongate susceptor elements in the one or two predominant dimensions, respectively, and a pre-defined reference axis of the article, in particular a length axis of the article, is in a range between +30 degrees and −30 degrees, in particular between +25 degrees and −25 degrees, more particularly between +10 degrees and −10 degrees.

Example Ex10: The aerosol-generating article according to any one of the preceding examples, wherein a density of the 1D-elongate or 2D-elongate susceptor elements within the aerosol-forming substrate is in a range between 0.001 susceptor elements per cubic millimeter and 30 susceptor elements per cubic millimeter, in particular between 0.1 susceptor elements per cubic millimeter and 10 susceptor elements per cubic millimeter; or wherein a mass density of the 1D-elongate or 2D-elongate susceptor elements within the aerosol-forming substrate is in a range between 0.002 milligram of susceptor mass per cubic millimeter and 0.3 milligram susceptor mass per cubic millimeter, in particular between 0.01 milligram of susceptor mass per cubic millimeter and 0.1 milligram of susceptor mass per cubic millimeter.

Example Ex11: The aerosol-generating article according to any one of the preceding examples, wherein the 1D-elongate susceptor elements have one of an elongate cylindrical shape or a prolate-ellipsoidal shape; or wherein the 2D-elongate susceptor elements have one of an oblate cylindrical shape or an oblate-ellipsoidal shape or a flake shape or plate shape.

Example Ex12: The aerosol-generating article according to any one of the preceding examples, wherein the 1D-elongate susceptor elements are one of fiber elements, in particular chopped fiber elements or milled fiber elements, or wire elements, or thread elements, or grain elements or rod elements.

Example Ex13: The aerosol-generating article accordingly any one of the preceding examples, wherein a cross-section of the 1D-elongate susceptor elements in a plane perpendicular to the one predominant dimension of the susceptor element has a circular shape or an oval shape or an elliptical shape or a triangular shape or a rectangular shape or a quadric shape or polygonal shape; or wherein a cross-section of the 2D-elongate susceptor elements in a plane parallel to the two predominant dimensions has a circular shape or an oval shape or an elliptical shape or a triangular shape or a rectangular shape or a quadric shape or polygonal shape.

Example Ex14: The aerosol-generating article according to any one of the preceding examples, wherein the susceptor material of the 1D-elongate or 2D-elongate susceptor elements is electrically conductive; or wherein the susceptor material of the 1D-elongate or 2D-elongate susceptor elements is electrically non-conductive.

Example Ex15: The aerosol-generating article according to any one of the preceding examples, wherein the susceptor material of the 1D-elongate or 2D-elongate susceptor elements comprises or consists of a metal, for example ferritic iron, or stainless steel, in particular a grade 410, grade 420, or grade 430 stainless steel; or a ferrimagnetic ceramic.

Example Ex16: The aerosol-generating article according to any one of the preceding examples, wherein the 1D-elongate or 2D-elongate susceptor elements further comprise a ferromagnetic or ferrimagnetic temperature maker material in addition to the susceptor material.

Example Ex17: The aerosol-generating article according to example 16, wherein the temperature maker material of the 1D-elongate or 2D-elongate susceptor elements comprises or consists of nickel or a nickel alloy.

Example Ex18: The aerosol-generating article according to any one of examples 16 to 17, wherein the temperature maker material of the 1D-elongate or 2D-elongate susceptor elements has a Curie temperature in a range between 180° C. and 420° C., in particular between 210° C. and 380° C., preferably between 250° C. and 380° C.

Example Ex19: The aerosol-generating article according to any one of examples Ex16 to Ex18, wherein the susceptor material is surrounded by the temperature maker material.

Example Ex20: The aerosol-generating article according to any one of the preceding examples, wherein the 1D-elongate or 2D-elongate susceptor elements comprise an outer protective coating surrounding the susceptor material and—if present—the temperature marker material.

Example Ex21: The aerosol-generating article according to any one of the preceding examples, wherein in addition to the plurality of 1D-elongate or 2D-elongate susceptor elements the susceptor arrangement comprises one or more temperature maker elements comprising a ferromagnetic or ferrimagnetic temperature maker material.

Example Ex22: The aerosol-generating article according to example Ex21, the temperature maker elements are dispersed throughout the aerosol-forming substrate.

Example Ex23: The aerosol-generating article according to any one of example Ex21 or example Ex22, wherein the temperature maker material of the one or more temperature maker elements comprises or consists of nickel or a nickel alloy.

Example Ex24: The aerosol-generating article according to any one of examples Ex21 to Ex23, wherein the temperature maker material of the one or more temperature maker elements has a Curie temperature in a range between 180° C. and 420° C., in particular between 210° C. and 380° C., preferably between 250° C. and 380° C.

Example Ex25: The aerosol-generating article according to any one examples Ex21 to Ex24, wherein the one or more temperature maker elements comprise an outer protective coating.

Example Ex26: The aerosol-generating article according to any one examples Ex21 to Ex25, wherein the one or more temperature maker elements are particulate temperature maker elements or equidimensional temperature maker elements or 1D-elonagte temperature maker elements or 2D-elongate temperature maker elements, in particular 1D-elonagte or 2D-elongate temperature maker elements having the same shape and/or the same dimensions as the 1D-elongate or 2D-elongate susceptor elements.

Example Ex27: The aerosol-generating article according to any one of the preceding examples, wherein the aerosol-forming substrate is made from a sheet material, and wherein the 1D-elongate or 2D-elongate susceptor elements are disposed on an outer surface of the sheet material or at least partially embedded in the sheet material close to an outer surface of the sheet material.

Example Ex28: The aerosol-generating article according to any one of the preceding examples, wherein the aerosol-forming substrate comprises at least one aerosol former and at least one sensorial material which are volatilizable when heated.

Example Ex29: An aerosol-generating system comprising an aerosol-generating article according to any one of the preceding examples, and an inductively heating aerosol-generating device for use with the article.

Examples will now be further described with reference to the figures in which:

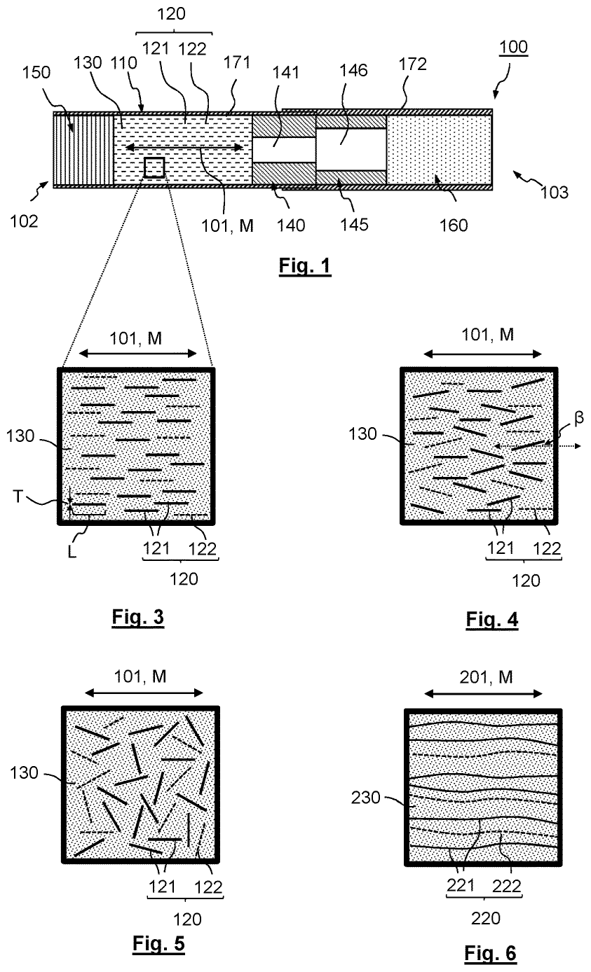

FIG. 1 schematically illustrates an exemplary embodiment of an inductively heatable aerosol-generating article according to the present invention comprising a susceptor arrangement with a plurality of 1D-elongate susceptor elements;

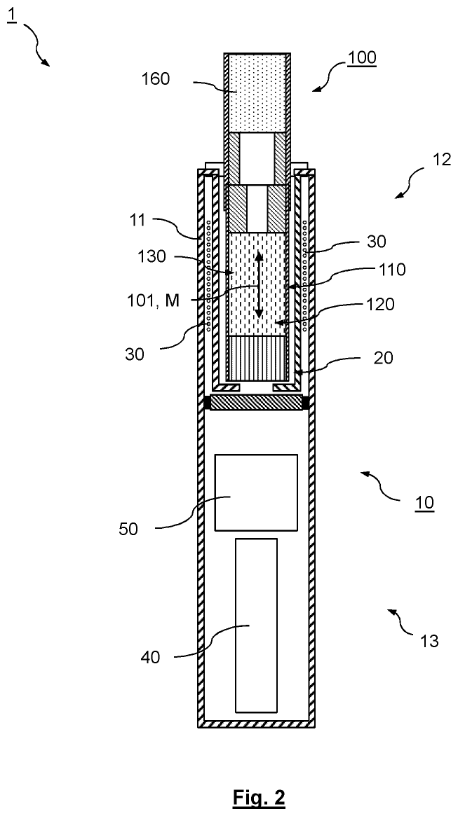

FIG. 2 schematically illustrates an exemplary embodiment of an aerosol-generating system comprising the aerosol-generating article according to FIG. 1;

FIG. 3 shows details of the susceptor arrangement of the article according to FIG. 1;

FIG. 4 shows details of another embodiment of the susceptor arrangement;

FIG. 5 shows details of yet another embodiment of the susceptor arrangement;

FIG. 6 shows details of still yet another embodiment of the susceptor arrangement;

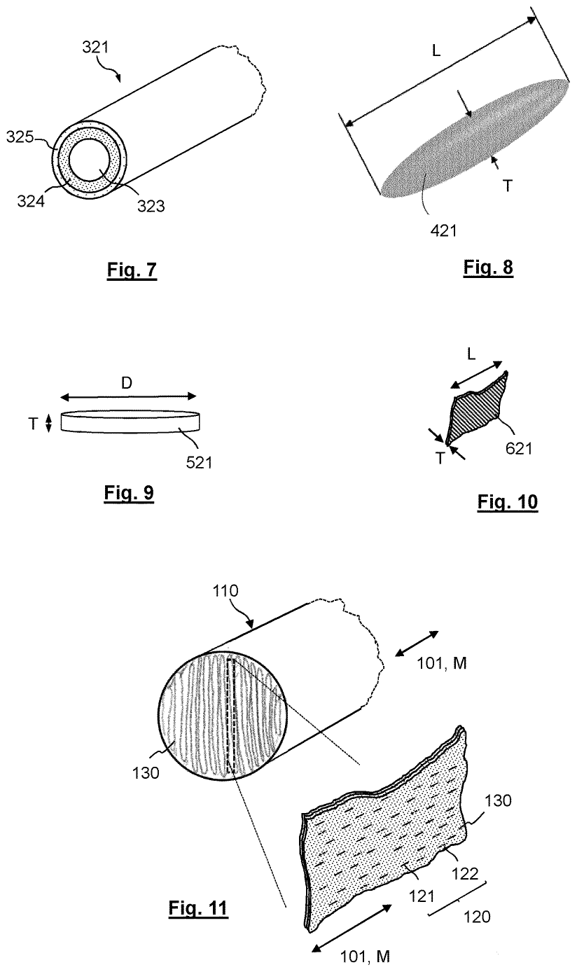

FIG. 7 shows details of an alternative embodiment of a 1D-elongate susceptor element;

FIG. 8 shows details of another alternative embodiment of a 1D-elongate susceptor element;

FIG. 9 shows details of an exemplary embodiment of a 2D-elongate susceptor element;

FIG. 10 shows details of an alternative embodiment of a 2D-elongate susceptor element; and

FIG. 11 shows details of the substrate element of the article according to FIG. 1.

FIG. 1 schematically illustrates an exemplary embodiment of an inductively heatable aerosol-generating article 100 according to the present invention (not to scale). The aerosol-generating article 100 is a substantially rod-shaped consumable comprising five elements sequentially arranged in coaxial alignment: a distal front plug element 150, a substrate element 110, a first tube element 140, a second tube element 145, and a filter element 160. The distal front plug element 150 is arranged at a distal end 102 of the article 100 to cover and protect the distal front end of the substrate element 110, whereas the filter element 160 is arranged at a proximal end 103 of the article 100. Both, the distal front plug element 150 and the filter element 160 may be made of the same filter material. The filter element 160 preferably serves as a mouthpiece, especially as part of a mouthpiece together with the second tube element 145. The filter element may have a length of 10 millimeter to 14 millimeter, for example, 12 millimeter, and the distal front plug element 150 may have a length of 3 millimeter to 6 millimeter, for example, 5 millimeter. Each one of the first and the second tube element 140, 145 is a hollow cellulose acetate tube having a central air passage 141, 146, wherein a cross-section of the central air passage 146 of the second tube element 145 is larger than a cross-section of the central air passage 141 of the first tube element 140. The first and second tube element 140, 145 may have a length of 6 millimeter to 10 millimeter, for example, 8 millimeters. The substrate element 110 comprises an aerosol-forming substrate 130 to be heated as well as a susceptor arrangement 120 for heating the substrate 130. In the present embodiment, the susceptor arrangement 120 comprises a plurality of 1D-elongate susceptor elements 121 comprising a ferromagnetic or ferrimagnetic susceptor material which are dispersed throughout the aerosol-forming substrate 130 in order to achieve a homogenous heating of the substrate 130. The substrate element 110 may have a length of 10 millimeter to 14 millimeter, for example, 12 millimeter. Each of the aforementioned elements 150, 110, 140, 145, 160 may be substantially cylindrical. In particular, all elements 150, 110,140, 145, 160 may have the same outer cross-sectional shape and dimensions. In addition, the elements may be circumscribed by one or more outer wrappers such as to keep the elements together and to maintain the desired cross-sectional shape of the rod-shaped article. In the present embodiment, the distal front plug element 150, the substrate element 110 and the first tube element 140 are circumscribed by a first wrapper 140, whereas the second tube element 145 and the filter element 160 are circumscribed by a second wrapper 172. The second wrapper 172 also circumscribes at least a portion of the first tube element 140 (after being wrapped by the first wrapper 171) to connect the distal front plug element 150, the substrate element 110 and the first tube element 140 being circumscribed by the first wrapper 171 to the second tube element 145 and the filter element 160. Preferably, the first and the second wrapper 171, 172 are made of paper. In addition, the second wrapper 172 may comprise perforations around its circumference (not shown). The wrappers 171, 172 may further comprise adhesive that adheres the overlapped free ends of the wrappers to each other.

As illustrated in FIG. 2, the aerosol-generating article 100 is configured for use with an inductively heating aerosol-generating device 10. Together, the device 10 and the article 100 form an aerosol-generating system 1 according to the present invention. The aerosol-generating device 10 comprises a cylindrical receiving cavity 20 defined within a proximal portion 12 of the device 10 for receiving a least a distal portion of the article 100 therein. The device 10 further comprises an inductive heating arrangement including an induction coil 30 for generating a high-frequency alternating magnetic field within the cavity 20. In the present embodiment, the induction coil 30 is a helical coil circumferentially surrounding the cylindrical receiving cavity 20. Due to the cylindrical shape of the helical coil 30, the alternating magnetic field in the cavity is substantially homogeneous within a space surrounded by the helical coil induction coil 30, with magnetic field lines running substantially in parallel to the length axis of the cavity 20. The induction coil 30 is arranged such that the substrate portion 110 of the article 100 including the susceptor arrangement 120 is exposed to the alternating magnetic field upon inserting the article 100 into the cavity 20 of the device 10. Thus, when activating the inductive heating arrangement, the susceptor elements 121 of the susceptor arrangement 120 heat up due to eddy currents and/or hysteresis losses that are induced by the alternating magnetic field depending on the magnetic and electric properties of the susceptor material of the susceptor elements 121. The susceptor arrangement 120 is heated until reaching a temperature sufficient to vaporize the aerosol-forming substrate 130. As a consequence, volatile compounds are released from the aerosol-forming substrate 130 in the substrate element 110 in order to form an aerosol which may be drawn through the first and second tube element 140, 145 and the filter element 160 towards the proximal end 103 of the article 100. Within a distal portion 13, the aerosol-generating device 10 further comprises a DC power supply 40 and a controller 50 (only schematically illustrated in FIG. 2) for powering and controlling the heating process. Apart from the induction coil 30, the inductive heating arrangement preferably is at least partially integral part of the controller 50.

FIG. 3 shows a detailed view (not to scale) of a portion of the substrate element 110 used within the aerosol-generating article 100 shown in FIG. 1. As mentioned above, the substrate element 110 comprises a plurality of 1D-elongate susceptor elements 121, that is, susceptor elements which have a greater extent in one predominant dimension than in the two remaining dimensions. In the present embodiment, the 1D-elongate susceptor elements 121 are chopped fiber elements having a substantially cylindrical shape with the length dimension corresponding to the one predominant dimension and the transverse dimensions (thickness) perpendicular to the length dimension corresponding to the two remaining dimensions. According to the present invention, it has been found that the heating efficiency and thus the extraction efficiency of the substrate is particularly enhanced, if the susceptor elements have a 1D-elongate shape, that is, a shape in which the length dimension of the susceptor element is predominate over any transverse dimensions perpendicular to the length dimension. As explained further above, the enhanced heating efficiency is due to the fact that the strength of the demagnetization field which is induced in the susceptor elements when exposed to the external alternating magnetic field of the induction heating arrangement is enhanced for a 1D-elongate shape as compared, for example, to a spherical shape. The heating efficiency of the multi-element susceptor arrangement is greater the more 1D-elongate susceptor elements are aligned along their length dimension (predominant dimension) in parallel the external alternating magnetic of the induction heating arrangement.

The heating efficiency and thus the extraction efficiency of the substrate is particularly enhanced if an aspect ratio of a maximum extent of the 1D-elongate susceptor elements in the one predominant dimension, that is, a length dimension of the 1D-elongate susceptor elements, to a maximum extent of the 1D-elongate susceptor in the two remaining dimensions, that is, a maximum transverse extent of the 1D-elongate susceptor elements perpendicular to the length dimension is greater than 4, in particular greater than 10, preferably greater than 20, more preferably greater than 25. In the embodiment according to FIG. 1 and FIG. 3, the chopped fiber elements have a maximum length extent L in a range between 0.8 millimeter and 1.2 millimeter (on average about 1 millimeter), and a maximum transverse extent T perpendicular to the length extent L, that is, a diameter T of about 25 micrometer. As a result, in the embodiment shown in FIGS. 1, 2 and 3, the aspect ratio of the maximum length extent L to the maximum transverse extent T of the 1D-elongate susceptor elements 121 (form factor) is about 40 on average, which is well-above the preferred threshold value of 4.

As mentioned before, the heating efficiency is at maximum if the 1D-elongate susceptor elements 121 are all aligned in parallel to the orientation M of the alternating magnetic field. Accordingly, the 1D-elongate susceptor elements 121 within the substrate element 110 shown in FIG. 1 and FIG. 3 are all aligned along their length dimension (predominant dimension) substantially in parallel with a pre-defined reference axis of the article 100, here the length axis 101 of the article 100, which coincides with the orientation M of the magnetic field lines at the position of the substrate element 110 within the cavity 20, when the article 100 according to FIG. 1 is engaged with aerosol-generating device as shown in FIG. 2.

The 1D-elongate susceptor elements 121 do not necessarily need to be in perfect parallel alignment with the length axis 101 of the article 100 and the orientation M of the magnetic field lines at the position of the substrate element 110 within the cavity 20, respectively. Even if the 1D-elongate susceptor elements 121 are aligned in a certain angular range about the length axis 101 of the article as shown in FIG. 4, the overall heating performance is still higher than for a susceptor arrangement with randomly oriented 1D-elongate susceptor elements. As indicated in FIG. 4, the 1D-elongate susceptor elements 121 may advantageously be aligned within the aerosol-forming substrate 130 such that an angle β between the maximum extent in the one predominant dimensions (length dimension) of the 1D-elongate susceptor elements and a pre-defined reference axis of the article, in particular the length axis 101 of the article 100, is in a range between +30 degrees and −30 degrees, in particular between +25 degrees and −25 degrees, more particularly between +10 degrees and −10 degrees.

Nevertheless, when considering an ensemble of susceptor elements, the overall heating performance of an ensemble of 1D-elongate susceptor elements 121 is still higher on statistical average than that of an ensemble of equidimensional susceptor elements, even if the 1D-elongate susceptor elements 121 are not all aligned in parallel or within a certain angular range, but randomly oriented as shown in FIG. 5. Hence, in any case the overall heating performance of the proposed susceptor arrangement 120 of 1D-elongate susceptor elements 121 is higher than for a similar configuration of equidimensional susceptor elements, regardless of whether the 1D-elongate susceptor elements are dispersed throughout the substrate with random orientation or within a certain angular range or in parallel to the orientation M of the alternating magnetic field used for induction heating.

In addition to the plurality of 1D-elongate susceptor elements 121, the susceptor arrangement 120 according to the embodiment shown in FIGS. 1-6 comprises a plurality of temperature maker elements 122 in the form of chopped fiber elements similar to the chopped fiber elements forming the 1D-elongate susceptor elements 121. The temperature maker elements 122 comprise a ferromagnetic temperature maker material which is chosen such as to have a Curie temperature which essentially corresponds to a predefined maximum heating temperature of the susceptor arrangement 120. When the temperature of the susceptor arrangement 120 and the aerosol-forming substrate 130 reaches the Curie temperature of the temperature maker material, the magnetic permeability of the temperature maker material drops to unity leading to a change of its magnetic properties from ferromagnetic to paramagnetic. The change of the magnetic properties is accompanied by a temporary change of the electrical resistance of the susceptor arrangement 120, as well as a temporary change of the inductance of the induction heating arrangement. Thus, by monitoring a corresponding change of the electrical current through the induction heating arrangement of the device 10, it can be detected when the temperature maker material has reached its Curie temperature and, thus, when the predefined temperature point has been reached. Advantageously, the Curie temperature is below 500° C., in particular equal to or below 400° C., more particularly equal to or below 390° C., in order to avoid local overheating or even burning of the aerosol-forming substrate 130. For example, the temperature maker material of the temperature maker elements may have a Curie temperature in a range between 180° C. and 420° C., in particular between 210° C. and 380° C., preferably between 250° C. and 380° C. Preferably, the ferromagnetic or ferrimagnetic temperature maker material of the temperature maker elements 122 may comprise or may consist of nickel or a nickel alloy. As an example, the temperature maker material of the one or more temperature maker elements may comprise or may consist of a Ni—Fe-alloy, in particular a Ni—Fe-alloy comprising 75 wt %-85 wt % Ni and 10 wt %-25 wt % Fe. As can be further seen from FIGS. 3-6, the temperature marker elements 122 may dispersed thorough the aerosol-forming substrate 130—like the susceptor elements 121—either with random orientation (FIG. 5) or within a certain angular range (FIG. 4) or in parallel to the orientation M (FIG. 3 and FIG. 6) of the alternating magnetic field used for induction heating.

In alternative to the temperature maker elements 122 shown FIGS. 1-5, the susceptor elements themselves may comprise a ferro- or ferrimagnetic temperature maker material with a Curie temperature chosen to correspond to a predefined maximum heating temperature of the susceptor arrangement. For example, as shown in FIG. 7, the 1D-elongate susceptor elements 321 may be formed as fiber elements with a susceptor material 323 forming a fiber core that is surrounded by a temperature maker material 324. That is, the temperature maker material 324 may be a coating or a layer surrounding the susceptor material 323. Advantageously, the temperature maker material 324 and the susceptor material 323 are intimately coupled to each other. For example, the temperature maker material 324 may be coated onto the susceptor material 323, such as by dip coating. As further shown in FIG. 7, the 1D-elongate susceptor element 321 may comprise an outer protective coating 325 surrounding the susceptor material 323 and the temperature marker material 324. Preferably, the protective coating 325 is an anti-corrosion coating making the susceptor element 321 resistant to external influences, especially corrosive influences.

Instead of chopped fiber elements as shown FIGS. 1-5, the susceptor arrangement 220 may comprise a plurality of 1D-elongate susceptor elements 221 in form of thread elements or filament elements. This is shown in FIG. 6. Like in FIG. 3, the thread elements or filament elements are arranged substantially in parallel with the length axis 201 of the article, which in turn coincides with the orientation M of the magnetic field lines at the position of the substrate element in use with the aerosol-generating device. The thread elements or filament elements may extend along the entire length dimension of the substrate element.

As alternative to fiber elements, thread elements or filament elements, the susceptor arrangement may comprise a plurality of 1D-elongate susceptor elements 421 in the form of grain elements. FIG. 8 shows an exemplary embodiment of such a grain element. The grain-like susceptor element 421 has a prolate-ellipsoidal shape with a maximum extent in the one predominant dimension (length extent L) of about 4.5 millimeter and a maximum extent in the two remaining dimension (transverse extent T) of 1 millimeter, that is, with a form factor of about 4.5. The susceptor element 421 may be made of, for example, a ferrimagnetic ceramic material with a Curie temperature below 400° C. The grain-like susceptor element 421 may be dispersed thought the aerosol-forming substrate, either with random orientation or within a certain angular range or in parallel to the orientation M of the alternating magnetic field used for induction heating.

FIG. 9 and FIG. 10 show alternative embodiments of a 2D-elongate susceptor element 521, 621, that is, a susceptor element having a greater extent in two predominant dimensions than in the remaining dimension perpendicular thereto. In FIG. 9, the 2D-elongate susceptor element 521 has an oblate (circular) cylindrical shape, with a maximum extent D in two predominant dimensions (here the radial dimensions) corresponding to the diameter of the oblate (circular) cylindrical shape of about 2 millimeter, and a maximum extent T in remaining non-predominant dimensions corresponding to the height of the oblate (circular) cylindrical shape of about 200 micrometer. Accordingly, the aspect ratio (form factor) of the maximum extent D in the two predominant dimensions to the maximum extent T in the remaining non-predominant dimension is about 10. As evident from FIG. 9, the cross-section of the 2D-elongate susceptor element 521 in a plane parallel to the two predominant dimensions has a circular shape in accordance to the overall circular cylindrical shape of the susceptor element 521. In contrast to the rather symmetrical shape in FIG. 9, the 2D-elongate susceptor element 621 shown in FIG. 10 has a flake shape, that is, a flat plate-like configuration with a surrounding uneven (craggy) edge. The extent of the susceptor element 621 in the plane of the flat flake-like shape is predominant over the thickness T. Accordingly, the plane of the flat flake shape defines the two predominant dimensions in which the susceptor element 621 has a greater extent than in the one remaining non-predominant dimension which is defined along the direction of the thickness T perpendicular to the plane of the flat flake-like shape. As can be further seen in FIG. 10, the susceptor element 621 has a greater extent in one distinct direction within the plane of the flat flake-like shape, which defines the maximum extent L of the susceptor element 621 in the two predominant dimensions. In the present embodiment, the maximum extent L in two predominant dimensions is about 3 millimeter, whereas the thickness T, that is, the maximum extent T in the one remaining non-predominant dimension is about 100 micrometer. Accordingly, the aspect ratio (form factor) of the maximum extent L in two predominant dimensions to the maximum extent T in the remaining non-predominant dimension is about 30.

FIG. 11 shows a perspective view of a portion of the substrate element 110 included in the article 100 according to FIG. 1, including a detailed view (bottom right) of its inner structure, in particular the structure of aerosol-forming substrate 130 and the susceptor arrangement 120. As can be seen from both, the perspective view and the detailed view, the aerosol-forming substrate 130 is made from a sheet material. For example, the aerosol-forming substrate 130 may be made from a crimped tobacco sheet comprising a tobacco material, organic fibers, a binder, an aerosol former that has been gathered into the cylindrical shape the substrate element 110. As can be further seen from the detailed view, the 1D-elongate susceptor elements 121 as well as the temperature marker elements 122 are disposed on the outer surface of the sheet material which can be still observed even though the sheet material is crimped and gathered. This may be the result of a manufacturing process including the deposition of the susceptor elements 121 and the temperature marker elements 122 on the outer surface of the sheet material, either during a primary process, in which the sheet material is produced, or during a secondary process, where the sheet material is machined. To this extent, it has been found that the preferred alignment of the 1D-elongate susceptor elements 121 and the temperature marker elements 122 relative to the pre-defined article axis, here the length axis 101 of the final article 100, is particularly easy to achieve, if the 1D-elongate susceptor elements 121 and the temperature marker elements 122 are applied to the aerosol-forming substrate 130 when it is in the form of a sheet material.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-14. (canceled)

15. An aerosol-generating article for an inductively heating aerosol-generating device, the aerosol-generating article comprising:
an aerosol-forming substrate; and
a susceptor arrangement configured to heat the aerosol-forming substrate by interaction of the susceptor arrangement with an alternating magnetic field provided by the aerosol-generating device,
wherein the susceptor arrangement comprises a plurality of 1D-elongate susceptor elements,
wherein the 1D-elongate susceptor elements have a greater extent in one predominant dimension than in the two remaining dimensions,
wherein the 1D-elongate susceptor elements comprise a ferromagnetic or ferrimagnetic susceptor material and are dispersed throughout the aerosol-forming substrate,
wherein the 1D-elongate susceptor elements further comprise a ferromagnetic or ferrimagnetic temperature marker material in addition to the susceptor material, the susceptor material being surrounded by the temperature marker material,
wherein an aspect ratio of a maximum extent of the 1D-elongate susceptor elements in the one predominant dimension to a maximum extent of the 1D-elongate susceptor elements in the remaining dimensions is greater than 4, and
wherein the 1D-elongate susceptor elements are one of fiber elements, or wire elements, or thread elements, or grain elements.

16. The aerosol-generating article according to claim 15, wherein the fiber elements are chopped fiber elements or milled fiber elements.

17. The aerosol-generating article according to claim 15, wherein the aspect ratio of the maximum extent of the 1D-elongate susceptor elements in the one predominant dimension to the maximum extent in the remaining dimensions is greater than 10.

18. The aerosol-generating article according to claim 17, wherein the aspect ratio of the maximum extent of the 1D-elongate susceptor elements in the one predominant dimension to the maximum extent in the remaining dimensions is greater than 35.

19. The aerosol-generating article according to claim 15, wherein the aspect ratio of the maximum extent of the 1D-elongate susceptor elements in the one predominant dimension to the maximum extent in the remaining dimensions is in a range between 4 and 500.

20. The aerosol-generating article according to claim 15, wherein the aspect ratio of the maximum extent of the 1D-elongate susceptor elements in the one predominant dimension to the maximum extent in the remaining dimensions is in a range between 30 and 100.

21. The aerosol-generating article according to claim 15, wherein the maximum extent of the 1D-elongate susceptor elements in the one predominant dimension is in a range between 0.02 micrometer and 50 millimeters.

22. The aerosol-generating article according to claim 15, wherein the maximum extent of the 1D-elongate susceptor elements in the one predominant dimension is in a range between 0.1 millimeter and 5 millimeters.

23. The aerosol-generating article according to claim 15,
wherein the maximum extent of the 1D-elongate susceptor elements in the remaining dimensions is a range between 0.005 micrometer and 500 micrometers, or
wherein the maximum extent of the 1D-elongate susceptor elements in the remaining dimensions is equal to or smaller than 500 micrometers.

24. The aerosol-generating article according to claim 15,
wherein the maximum extent of the 1D-elongate susceptor elements in the remaining dimensions is a range between 20 micrometers and 100 micrometers, or
wherein the maximum extent of the 1D-elongate susceptor elements in the remaining dimensions is 1 micrometer.

25. The aerosol-generating article according to claim 15,
wherein the 1D-elongate susceptor elements are randomly oriented within the aerosol-forming substrate, or
wherein, with respect to the maximum extent in the one predominant dimension, respectively, the 1D-elongate susceptor elements are aligned substantially parallel to a predefined reference axis of the aerosol-generating article, or
wherein the 1D-elongate susceptor elements are aligned within the aerosol-forming substrate such that an angle between the maximum extent in the one predominant dimension, respectively, and a predefined reference axis of the aerosol-generating article, is in a range between +30 degrees and −30 degrees.

26. The aerosol-generating article according to claim 15,
wherein the 1D-elongate susceptor elements are randomly oriented within the aerosol-forming substrate, or
wherein, with respect to the maximum extent in the one predominant dimension, respectively, the 1D-elongate susceptor elements are aligned substantially parallel to a predefined reference axis of the aerosol-generating article, or
wherein the 1D-elongate susceptor elements are aligned within the aerosol-forming substrate such that an angle between the maximum extent in the one predominant dimension, respectively, and a predefined reference axis of the aerosol-generating article, is in a range between +10 degrees and −10 degrees.

27. The aerosol-generating article according to claim 15,
wherein the 1D-elongate susceptor elements are randomly oriented within the aerosol-forming substrate, or
wherein, with respect to the maximum extent in the one predominant dimension, respectively, the 1D-elongate susceptor elements are aligned substantially parallel to a length axis of the aerosol-generating article, or
wherein the 1D-elongate susceptor elements are aligned within the aerosol-forming substrate such that an angle between the maximum extent in the one predominant dimension, respectively, and a length axis of the article, is in a range between +30 degrees and −30 degrees.

28. The aerosol-generating article according to claim 15,
wherein the 1D-elongate susceptor elements are randomly oriented within the aerosol-forming substrate, or
wherein, with respect to the maximum extent in the one predominant dimension, respectively, the 1D-elongate susceptor elements are aligned substantially parallel to a length axis of the aerosol-generating article, or
wherein the 1D-elongate susceptor elements are aligned within the aerosol-forming substrate such that an angle between the maximum extent in the one predominant dimension, respectively, and a length axis of the article, is in a range between +10 degrees and −10 degrees.

29. The aerosol-generating article according to claim 15, wherein the 1D-elongate susceptor elements have one of an elongate cylindrical shape or a prolate-ellipsoidal shape.

30. The aerosol-generating article according to claim 15, wherein the susceptor material of the 1D-elongate susceptor elements comprises a metal, or stainless steel, or a ferrimagnetic ceramic.

31. The aerosol-generating article according to claim 15, wherein the temperature marker material of the 1D-elongate susceptor elements comprises nickel or a nickel alloy.

32. The aerosol-generating article according to claim 15, wherein the 1D-elongate susceptor elements comprise an outer protective coating surrounding the susceptor material and the temperature marker material.

33. The aerosol-generating article according to claim 15, wherein in addition to the plurality of 1D-elongate susceptor elements the susceptor arrangement further comprises one or more temperature maker elements comprising a ferromagnetic or ferrimagnetic temperature maker material.

34. The aerosol-generating article according to claim 15,
wherein the aerosol-forming substrate is made from a sheet material, and
wherein the 1D-elongate susceptor elements are disposed on an outer surface of the sheet material or at least partially embedded in the sheet material close to an outer surface of the sheet material.
